(19) United States
(12) Patent Application Publication
(10) Pub. No.: US 2025/0062970 A1
(43) Pub. Date: Feb. 20, 2025

(54) SYSTEM AND METHODS FOR MISSION EXECUTION IN NETWORK

(71) Applicant: HUAWEI TECHNOLOGIES CO., LTD., SHENZHEN (CN)

(72) Inventors: Weisen SHI, Kanata (CA); Xu LI, Kanata (CA); Chenchen YANG, Guangdong (CN)

(73) Assignee: HUAWEI TECHNOLOGIES CO., LTD., SHENZHEN (CN)

(21) Appl. No.: 18/936,346

(22) Filed: Nov. 4, 2024

Related U.S. Application Data
(63) Continuation of application No. PCT/CN2023/076225, filed on Feb. 15, 2023.

(51) Int. Cl. H04L 41/5051

(52) U.S. Cl. CPC H04L 41/5051

(57) ABSTRACT

An X-centric network architecture and associated methods are provided. The network architecture provides comprehensive control and processing functions that support heterogenous XaaS services. For different XaaS services, the network architecture supports the activation/selection of different functions/interfaces. The network architecture has a control/management (C/M) plane that includes a mission manager (MM) that manages a mission comprising tasks associated with heterogenous services. The network architecture also has a mission data plane (MDP) coupled to the C/M plane. The MDP plane includes processing functions (PFs) required for the tasks and also includes data plane functions (DPFs) that are configured to interface a PF of a XaaS service to a PF of a different XaaS service. The network architecture also has one or multiple XaaS module(s) which may be provided by third parties as plug-in module(s). Each XaaS module is associated with a XaaS service, one of multiple XaaS service controller(s) (XC), and one or multiple PF(s)/DPF(s) conducting corresponding tasks. Detail procedures, interfaces, and signals for mission execution and device accessing a mission (mission access) are described in the associated methods.

### CROSS-REFERENCE TO RELATED APPLICATIONS

This application is a continuation of International Patent Application No. PCT/CN2023/076225, filed Feb. 15, 2023, entitled “System and Methods for Mission Execution in Network” and claims the benefit of priority from U.S. Provisional Patent Application No. 63/354,500, filed on Jun. 22, 2022, the entire content of which is incorporated herein by reference.

### TECHNICAL FIELD

This invention pertains generally to the field of computerized communication systems and in particular to communication processes for implementing anything-as-a-service (XaaS) service delivery.

### BACKGROUND

With the rapid and unneglectable developing of artificial intelligence and machine learning (AI/ML), big data, and blockchain applications, the advanced computing capabilities and resources are becoming increasingly important from various corners of industry and life. Besides, the widely applied vertical applications, such as Internet of things (IoT), vehicle to everything (V2X), Metaverse, etc., are expected to create numerous highly distributed raw data to be computed and processed by the application side. However, the existing centralized computing solutions based on the Cloud or data-centers cannot support a fast response to the dynamicity of the distributed data sources due to the remote and complex routing paths between data sources and cloud servers.

To address this issue, it is expected that the computing and processing works of heterogeneous services can be decoupled from centralized cloud server nodes, and be deeply deployed into the network or edge (e.g. on radio node). As the next-generation mobile communications system, 6G is expected to go far beyond providing communication pipelines or connectivity to intelligence. 6G will employ a X-centric architecture to enable computing and processing capabilities of different services in a distributed and collaborated manner. The X-centric architecture is defined to support anything as a service (XaaS) services (or service in short) with heterogeneous processing and computing requirements. For instance, NET4AI (also referred to as Network AI) is a typical XaaS service that aims to intelligently connect distributed intelligent nodes/agents in the network to proliferate large-scale deployment of AI in all industries. In another instance, data analytics and management (DAM) is another XaaS service that aims to monitor and analyze data sources for the AI applications. To support XaaS services, the core network (CN)/radio access network (RAN) in 6G will be enabled with computing capabilities (i.e., modules/nodes to provide computing resources and management of computing procedures) and be redesigned with new control/management (C/M) plane functions to schedule/coordinate the network-based computing and processing capabilities.

Moreover, in some cases both the computing and processing capabilities, and part of the corresponding control functions for an XaaS service can be provided by third-party providers (e.g., an independent AI solution provider may design their own module containing the corresponding processing and control functions for a XaaS service and plug it in the 6G CN/RAN network). To support the third-party provided XaaS service modules, the future 6G networks should have a global control functionality across multiple XaaS services and define the general procedures of processing and control the XaaS services.

In known networks, the network-native (NN) processing capabilities and corresponding control mechanisms are defined to support general NN, transfer-learning, and vertical federated learning (VFL) services, respectively. To further support XaaS services, the existing solutions have the following issues to be solved.

Each existing prior art is focusing on a (or a class of) specific XaaS service(s) and defines a set of dedicated system functions and procedures. Since the future X-centric network must support heterogeneous services in one architecture, it is costly and inefficient to independently implement the known dedicated systems. Therefore, a general network architecture with corresponding processing and control functions suitable for all XaaS services is desirable.

In some prior art systems, the uses/selections of required processing/control functions are statically configured or pre-determined to achieve a specific purpose (or to solve a problem). However, in future network where multiple XaaS services are running simultaneously, the available computation and processing resources (e.g., network entities realizing processing/computing functions) can be limited and change dynamically. To address this issue, methods that can dynamically select processing/control functions for the execution of XaaS service are desirable.

Some prior art systems involve processing/control functions that are dedicated for a specific XaaS service. However, the future X-centric network should be able solve more complex problems that involve heterogeneous processing/control functions originally designed for different XaaS services. A mechanism that enables cooperative working among processing/control functions of multiple XaaS services is desirable.

Therefore, improvements in XaaS network architectures and associated methods are desirable.

This background information is provided to reveal information believed by the applicant to be of possible relevance to the present invention. No admission is necessarily intended, nor should be construed, that any of the preceding information constitutes prior art against the present invention.

### SUMMARY

The present invention is believed to address aforementioned issues in the prior art as described below.

In some embodiments, the present invention defines a general system/network architecture that comprises comprehensive control and processing functions (with the corresponding interfaces) to support heterogeneous XaaS services. For different XaaS services, the activated/selected functions/interfaces can be different, but all be supported in the general system/architecture.

In some embodiments, given the general system/architecture, the present invention allows to dynamically select network functions, or access points (of user equipment (UE) devices) to support XaaS service execution.

In some embodiments, considering the scenarios where XaaS services are third-party provided, the present invention provides solutions to cooperation/inter-working problems among control or processing functions of different services, and a global control function conducing overall management of heterogeneous functions.

In accordance with an embodiment of the present disclosure, there is provided a system that comprises a control/management (C/M) plane and a mission data plane. The C/M plane includes a mission manager (MM) that is configured to manage a mission, which comprises tasks associated with heterogenous services (different services) provided by respective XaaS modules. The mission data plane includes processing functions (PFs) that are comprised in the tasks. Each XaaS module comprises at least one PF. Each PF is configured to interface with at least one of: another PF, a device and an application server. The mission data plane also includes data plane functions (DPFs), which are comprised within tasks. Each DPF is configured to interface a first PF of a first XaaS module to a second PF of a second XaaS module. The MM is configured to manage the mission by scheduling and coordinating the tasks associated with the heterogenous services. The system is part of a network that has a network architecture. Advantageously, the arrangement of the C/M plane and of the mission data plane, as well as the configuration of the MM to manage the tasks related to the PFs and DPFs, allow for the support and execution of the heterogenous XaaS services in the network, and allow for the dynamic selection of network functions, or access points (of user equipment (UE) devices) to support XaaS service execution. The ability to support and execute heterogenous XaaS services can allow the network to undertake complex problems that require such heterogenous XaaS services. Further, the adaptability of the present system can avoid the need to implement costly dedicated systems and enable the reuse of capabilities (e.g., computing, NN network training/inferencing) provided by heterogeneous XaaS services.

In some embodiments, the MM is configured to dynamically schedule and coordinate the tasks in accordance with dynamic resource conditions or dynamic network conditions. In some embodiments, the MM is configured to schedule and coordinate the tasks in accordance with a pre-determined workflow. In some embodiments, the MM is centrally deployed in a network entity. In some embodiments, the MM is deployed at multiple network entities. The configuration of the MM allows the system to adapt rapidly to changes in the network resources or conditions. The configuration of the MM can also allow for the simple implementation of pre-determined workflows when foreseeable changes in the network resources or conditions are deemed minor. The ability to adapt rapidly to changes in the network resources or conditions can be of particular value when multiple XaaS services are running simultaneously, and the availability of the network or resources changes rapidly.

In some embodiments, an XaaS service can be provided by a XaaS module which includes PF(s)/DPF(s) and control functions that are needed to run/execute tasks associated with the XaaS service. Each XaaS module corresponds to a specific XaaS service. Advantageously, XaaS modules, and the services to which the modules are associated, can be provided by third parties as plug-in modules to the network. In some embodiments, each XaaS module comprises a respective XaaS service controller (XC). Each XC is coupled to the MM. Each XC is configured to schedule and coordinate an execution of PFs of the respective XaaS module and an execution of DPFs associated with the PFs. In some embodiments, each XC is further configured to steer data traffic in accordance with the respective XaaS service. In some embodiments, each XC is further configured to control devices or application servers associated with the tasks.

In some embodiments, the mission data plane (MDP) further includes devices and application servers (ASs) configured to execute specific tasks of the mission. In some embodiments, the mission data plane further includes interfaces interfacing the PFs, DPFs, devices and ASs in accordance with the tasks to be executed. In some embodiments, the MM is configured to, in accordance with a mission logic, establish at least one of: a data format, a communication parameter, a communication protocol, and a link topology for the PFs and the DPFs. The interfaces of the PFs, DPFs, devices and ASs allow for improved control and management of tasks associated with different XaaS services.

In some embodiments, the C/M plane defines a network registry (NRF) function configured to store and maintain pre-determined data associated with at least one of: the PFs, the DPFs, the tasks and the mission. In some embodiments, the C/M plane defines a network exposure function (NEF) configured to manage an interconnection between the XaaS modules and application functions (AFs), the AFs configured to create a mission, trigger a mission or both create a mission and trigger the mission. In some embodiments, the C/M plane defines a connectivity manager (CM) configured to manage an access of a device to the mission.

In some embodiments, the first XaaS module comprises a first DPF coupled to the first PF, the first DPF and the first PF forming a first XaaS data plane function (XDPF), the second XaaS module comprises a second DPF coupled to the second PF, the second DPF and the second PF forming a second XDPF, the first XDPF is coupled to the second XDPF, the PF of the first XaaS service is coupled to the PF of the second XaaS service via the DPF of the first XaaS service and the DPF of the second XaaS service.

In accordance with another embodiment of the present disclosure, there is provided a system. The system comprises a mission data plane (MDP). The MDP includes processing functions (PFs) each associated with one or more XaaS services, each PF configured to interface with at least another PF, a device and an application server. The MDP also includes data plane functions (DPFs), each DPF configured to interface a PF of a first XaaS service to a PF of a different XaaS service. The system comprises a control/management (C/M) plane that includes one or more XaaS service controller functions (XCs) each associated with one of the XaaS services and configured to control a PF of the associated XaaS service. The data plane and the C/M plane are configured to execute a mission comprising tasks, each task being related to an execution of at least on PF. The system is part of a network, which has a network architecture. Advantageously, the arrangement of the MDP and the C/M plane, as well as the configuration of the PFs, the device, the application server and the XC allow for the support and execution of the XaaS services in the network.

In some embodiments, the C/M plane further includes a mission manager (MM) associated with the mission. The MM is configured to schedule and coordinate the tasks of the mission.

In accordance with another embodiment of the present disclosure, there is provided a method that comprises, by a network exposure function (NEF), obtaining, from a device or an application function (AF), a mission execution request (MER) for a mission comprising tasks. The method further comprises, by the NEF, establishing a mission execution procedure to select a mission manager (MM) to manage the mission, and receiving, from the MM, a mission ready acknowledgment (ACK) message indicating the mission is ready for execution. The method also comprises, by the NEF, forwarding the mission ready ACK message to the device or the AF to cause an execution of the mission. The device, the AF, the NEF, and the MM are comprised in network elements in a network. The network elements further comprising at least one of: a network registry function (NRF), XaaS service controllers (XCs), processing functions (PFs), data plane functions (DPFs), a device, and an application server (AS). The method further comprises using the network elements other than the NEF and the NRF, to execute the tasks of the mission.

In various example the previous embodiment, an execution of the tasks comprises the MM sending, for a particular task, a task trigger message to an XC associated with the particular task. The task trigger message includes at least one of the identification of the particular task and a scheduled start time of the execution of the particular task.

In various examples of the previous embodiment, the MM is configured to conduct a XC selection and configuration procedure for a particular task to be triggered, and to conduct a trigger task execution procedure. The MM is configured to conduct a mission establishment procedure to establish a partial mission data plane for the task to be triggered, then to conduct a XC selection and configuration procedure for the task to be triggered, and the then conduct a trigger task execution procedure.

In various examples of the previous embodiment, the MM is configured to monitor the current running tasks and to manage the XCs associated to the running tasks by sending task management messages to the XCs associated to the running tasks.

In various examples of the previous embodiment, the content of the task management messages includes at least one of a task suspension signal, a task waiting time to start, and a resource utilization constraint for parallel running tasks.

In various examples of the previous embodiment, the MM is configured to modify the current mission data plane according to load balancing constraints or XC/device requests.

In various examples of the previous embodiment, the MM is configured to periodically send a notification message to the AF initiating the mission execution, the content of the notification message includes at least one of a mission start indicator or time, a current running task identification, a mission completion indicator, a device arrival/dropout indicator, and a mission execution result. A device arrival indicator indicates the access of one device to the mission, a device dropout indicator indicates the leave/quit of one device from the mission.

In various examples of the previous embodiment, the MM is configured to monitor the task execution complete message sent from the XCs.

In various examples of the previous embodiment, the MM is configured to, after receiving the task execution complete message, release the corresponding resources for the task managed by the selected XC sending the task execution complete message.

In various examples of the previous embodiment, for each task, the task execution is gradually conducted by the data sending, receiving and processing/computing behaviors running on the PFs and DPFs comprised in the task.

In various examples of the previous embodiment, the running of PFs/DPFs may be sequential or parallel according to the task execution logic and inter-dependency between the PFs/DPFs.

In various examples of the previous embodiment, after receiving the task trigger message sent from the MM, the XC is configured to send a message to the corresponding PFs/DPFs to execute their corresponding steps of the task.

In various examples of the previous embodiment, the message sent by the XC to the PFs and to the DPFs includes at least one of scheduled start times to execute corresponding steps of the task, and resource utilization constraints to execute the steps.

In various examples of the previous embodiment, the XC is configured to send an invitation message to invite the device to access the mission. The XC is configured to send a notification message to a DPF connected to the AS, to invite the AS to join the execution of the tasks. The XC is also configured to notify the NEF to notify the AF to invite the AS to join the execution of the tasks.

In various examples of the previous embodiment, the XC is configured to monitor the PFs and the DPFs and to provide management messages to the PFs and to the DPFs.

In various examples of the previous embodiment, the management messages comprise at least one of a PF/DPF running suspension signal, a PF/DPF waiting time start, resource utilization constraints for parallel running of the PF and the DPFs.

In various examples of the previous embodiment, XC is configured to send a mission data plane modification request message to the MM to re-select the associated PFs/DPFs due to load balancing or device access impacts. The XC is configured to periodically send a notification message to the MM, the notification message comprising at least one of: a task start indicator or time, a task execution complete message, a device arrival/dropout indicator, and a task execution result. The XC is also configured to receive work complete messages sent by the PFs and the DPFs, the work complete messages indicating the completion of the PFs and the DPFs running.

In various examples of the preceding embodiment, the NEF sends, to a network registry function (NRF), a query message for mission data associated with the MER. The NEF receives the mission data. The NEF then selects the MM to manage the mission in accordance with the mission data.

In various examples of the preceding embodiment, the NEF sends, to the MM, the MER and the mission data, and the MM establishes a mission data plane (MDP) in accordance with the MER and the mission data.

In various examples of the preceding embodiment, the MM, sends an establishment complete ACK message to the NEF; and the NEF sends, to the NRF, MM data for registration. The MM data may comprise an identification of the MM and an address/location of the MM.

In various examples of the preceding embodiment, the method comprises the MM sending, to the NRF, MM data for registration. The MM data comprises an identification of the MM and an address/location of the MM. And the NRF send, to the NEF, an establishment complete ACK message.

In various examples of the preceding embodiment, the MDP comprises processing functions (PFs) and data plane functions (DPFs). The MM sends, to the NRF, a query for information on available XaaS service controllers (XCs), receives the information on the available XCs, and selects, in accordance with the information on the available XCs, one of the available XCs to obtain a selected XC to manage a task comprising the PFs and the DPFs.

In various examples of the preceding embodiment, the MM sends, to the selected XC, a XC configuration message to configure the XC. The XC configuration message comprises data on the PFs and the DPFs comprised in the task to be managed by the selected XC controller.

In various examples of the preceding embodiment, the selected XC sends, to the PFs and the DPFs, a respective configuration message containing an identification of the selected XC.

In various examples of the preceding embodiment, the selected XC sends, to the MM, a XC configuration complete ACK message.

In another embodiment of the present disclosure, there is provided a method that comprises, by a device, sending, to a connectivity manager (CM) via a radio access network (RAN) node, a mission access request (MAR) to access the mission. The method also comprises, by the CM, conducting a serving mission manager (MM) procedure to select a serving MM. The method further comprises, by the serving MM, conducting a serving XaaS service controller (XC) procedure to select a serving XC to manage a task of a mission to be accessed by the device. The method additionally comprises, by the CM, establishing the RAN node to a serving XC interface (R2X interface) configured to control signals between the serving XC and the device. Furthermore, the method comprises, by the serving XC, sending an invite message to the device to join a data plane of the task via the R2X interface. Advantageously, the method provides the network functions and the actions/procedures that, when performed, allow for a device to access a mission in order to conduct specific processing functionalities/steps in a task of the mission.

In various examples of the preceding embodiment, the serving MM procedure comprises, by the CM, sending, to a network registry function (NRF), the MAR. The method further comprises, by the CM, receiving, from the NRF, a response message comprising an identification and a location/address of the MM that manages the mission. The method additionally comprises, by the CM, selecting as the serving MM, the MM that manages the mission; and sending, to the device, a message identifying the serving MM.

In various examples of the preceding embodiment, the CM sends, to a network registry function (NRF), a message to query the serving mission manager (MM) of the mission. When the mission has not been established, the CM receives from the NRF, a mission non-establishment message. The CM also forwards the mission non-establishment message to the device and sends a mission execution trigger request (METR) to an application function (AF), the METR comprising an expected mission start time. The CM receives, from the AF, a mission execution trigger time (METT). The CM sends the METT to the device and sends to the NRF a message containing a request to subscribe data of the serving MM to the mission. The AF triggers an establishment of the mission. The NRF sends the data of the serving MM to the CM, and the CM sends, to the device, a serving MM selected acknowledgment message.

In various examples of the preceding embodiment, the conducting the serving MM procedure comprises the CM sending, to a network registry function (NRF), a message to query the serving mission manager (MM) of the mission. The CM receives, from the NRF, a mission non-establishment message and forwards the mission non-establishment message to the device. The CM conducts a mission establishment procedure, which configured to select a serving MM to obtain a selected serving MM. The CM sends, to the device, a serving MM selected acknowledgment message.

In various examples of the preceding embodiment, conducting the serving XC procedure comprises the CM sending, to the serving MM, a message to initiate a selection of the serving XC. The MM, when a participant point is specified in the MAR, conducts an initial serving XC selection by selecting an XC corresponding to the participant point. When a participant point is not specified in the MAR, the MM translates an intention of the device to access the mission indicated in the MAR and to access a task of the mission. The MM selects, as the serving XC, the XC that manages the task.

In various examples of the preceding embodiment, when a determination is made, in accordance with serving MM data, that an interface for D2X communication is sharable, the CM checks if there is an R2X interface with appropriate parameters between the RAN node where the device is connected and the serving XC. When there is the R2X interface with the appropriate parameters, the CM selects the R2X interface for D2X communication. When a determination is made, in accordance with the serving MM data, that the interface for D2X communication is not sharable, the CM sets parameters for the R2X interface. The parameters include a control signal protocol, a minimum data rate/maximum delay threshold for control signal transmission.

In various examples of the preceding embodiment, the CM sends to the RAN and to the serving XC, messages containing an address for the R2X interface and communication parameters for the R2X interface. The CM activates the R2X interface. The serving XC sends an interface build-up acknowledgment message to the CM.

In another embodiment of the present disclosure, there is provided a method that comprises, by a network exposure function (NEF), sending, to a network registry function (NRF), a query message for mission data associated with a mission execution request (MER). The method further comprises the NEF receiving the mission data, and selecting a mission manager (MM) to manage the mission in accordance with the mission data. Advantageously, the method provides the network functions and the actions/procedures that, when performed, allow for selecting a MM which manages a mission, and triggering the execution of the mission.

In various examples of the previous embodiment, the NEF sends, to the MM, the MER and the mission data and, the MM establishes a mission data plane (MDP) in accordance with the MER and the mission data. In various examples of the previous embodiment, the MM sends an establishment complete ACK message to the NEF, and the NEF sends, to the NRF, MM data for registration. The MM data comprises an identification of the MM and an address/location of the MM. In various examples of the previous embodiment, the MM sends, to the NRF, MM data for registration. The MM data comprises an identification of the MM and an address/location of the MM. The NRF, sends, to the NEF, an establishment complete ACK message.

In another embodiment of the present disclosure, there is provided a method that comprises, by a mission manager (MM), sending, to a network registry function (NRF), a query for information on available XaaS service controllers (XCs). The method further comprises, at the MM, receiving the information on the available XCs, and selecting, in accordance with the information on the available XCs, one of the available XCs to obtain a selected XC to manage a task comprising processing functions (PFs) and data plane functions (DPFs) associated to a task. Advantageously, the method provides the network functions and the actions/procedures that, when performed, allow for the MM of a mission to select one or multiple XCs which manage the one or multiple tasks in the mission.

In various examples of the previous embodiment, the MM sends, to the selected XC, a XC configuration message to configure the XC. The XC configuration message comprises data on the PFs and the DPFs comprised in the task to be managed by the selected XC controller. In various examples of the previous embodiment, the method further comprises, by the selected XC, sending, to the PFs and the DPFs, a respective configuration message containing an identification of the selected XC. In various examples of the previous embodiment, the method further comprises, by the selected XC, sending, to the MM, a XC configuration complete ACK message.

In further examples of the previous embodiment, the selected XC sends, to the PFs, a PF configuration message identifying the selected XC. The selected XC then receives, from the PFs, a PF configuration ACK message to activate a control interface between the selected XC and the at least one of the PFs. In further examples of the previous embodiment, the PF configuration message includes a maximum computing resources usage for each of the PFs to execute the task. In further examples of the previous embodiment, the selected XC sends, to the MM, a DPF configuration request to configure the DPFs. In further examples of the previous embodiment, the DPF configuration request includes addresses of exposed PFs to be connected with the DPFs. In further examples of the previous embodiment, the MM sends a DPF configuration message to the DPFs, and the DPF configuration message contains the addresses of the exposed PFs to be connected with the DPFs. In further examples of the previous embodiment, the DPF configuration message further contains a maximum computing resources usage for each of the DPFs to execute the task. In further examples of the previous embodiment, the MM receives a DPF configuration ACK message from the DPFs, the DPF configuration ACK message is configured to activate a control interface between the MM and the DPFs. In further examples of the previous embodiment, the MM sends, to the selected XC, DPF data including control interface data associated with the control interface. In further examples of the previous embodiment, the DPF data includes DFP interfaces addresses to the PFs to be connected by the DPFs. In further examples of the previous embodiment, the selected XC sends, to the PFs, a PF to DPF (PF2DPF) configuration message to configure exposed control interface between the PF and the DPF. In further examples of the previous embodiment, the PF2DPF configuration message includes the configured DPFs interface addresses to the corresponding DPFs. In further examples of the previous embodiment, the selected XC receives, from the PFs, a PF2DPF configuration ACK message. In further examples of the previous embodiment, the MM receives, from the selected XC, a XC configuration result ACK indicating the completion of the XC selection and configuration.

In accordance with another embodiment of the present disclosure, there is provided a method that comprises, by a connectivity manager (CM), sending to a radio access network (RAN) node and to the serving XC, messages containing an address for R2X interface and communication parameters for the R2X interface. The CM then activates the R2X interface, and the serving XC, sends an interface build-up acknowledgment message to the CM.

In accordance with an embodiment of the present disclosure, there is provided an apparatus comprising one or more processors coupled with a memory storing instructions that when executed by the one or more processors cause the one or more processors to perform a method according to any one of the method embodiments described herein.

In accordance with another embodiment of the present disclosure, there is provide a medium storing instructions that when executed by an apparatus cause the apparatus to perform a method according to any one of the method embodiments described herein.

In accordance with another embodiment of the present disclosure, there is provided a method that comprises by a mission manager (MM), sending, to a XaaS controller (XC), a task trigger message containing an identification of a task to be controlled by the XC and a start time to start executing the task. In further examples of the previous embodiment, the MM select the XC and configures the XC. In further examples of the previous embodiment, the MM establishes a mission containing the task by establishing a mission data plane that includes processing function (PFs) associated with the task and data plane functions (DPFs); the PFs and the DPs are configured to be controlled by the XC; each of the DPFs is configured to interface at least one of the PFs to another one of the PFs. In further examples of the previous embodiment, the PFs and the DPFs are executed. In further examples of the previous embodiment, executing the PFs and the DPFs comprises, by the XC, sending, to the PF/PDF, a PF/DPF trigger message to the cause the PFs and the DPFs to execute actions associated with the task. In further examples of the previous embodiment, the PF/DPF message includes at least one of: a respective start time for the PFs and the DPFs to begin their respective execution; and respective PF and DPF resource utilization constraints In further examples of the previous embodiment the XC receives, from the PFs and the DPSs, when the PFs and the DPFs are executing, PF/DPF status info; the status info includes at least one of: a time a which the PFs and the DPFs began executing; a task execution completion message; a device arrival indictor; and a device dropout indicator. In further examples of the previous embodiment, the XC monitors the PFs and the DPFs that are executing, to obtain monitoring data; in accordance with the monitoring data, the XC sends, to the PFs and the DPFs that are executing, a PF/DPF management message to coordinate the executing PFs with the executing DPFs. In further examples of the previous embodiment, the PF/DPF management message includes at least one of: a PF/DPF running suspension signal; a PF/DPF waiting time to start; and a resource utilization constrains for a parallel execution of the PFs and the DPFs. In further examples of the previous embodiment, the XC receives, from the PFs and the DPFs, a PF/DPF complete message indicating the PFs and the DPFs have finished executing. In further examples of the previous embodiment, the PFs and the DPFs that are executing form a first set of executing PFs and DPFs, the method further comprising executing a second set of PFs and DPFs in parallel with the first set of executing PFs and DPFs. In further examples of the previous embodiment, the XC sends, to the MM, a task status message comprising at least one of a task start indicator, a task start time, a task execution complete message and a device arrival/dropout indicator. In further examples of the previous embodiment, when the task has completed, the task status message includes a task execution complete message and a device arrival/dropout indicator and the method further comprises, by the MM, releasing the resources that were required to execute the task. In further examples of the previous embodiment, the XC sends, to the MM, during or after an execution of the task, a mission data plane (MDP) request to cause the MM to reselect PFs/DPFs. In further examples of the previous embodiment, the MM sends, to the XC, a task management message comprising at least one of: a task suspension signal, a task waiting time to start and a resource utilization constraint for parallel running tasks. In further examples of the previous embodiment, the MM sends, to an application function (AF), a mission status message including at least one of a mission start indicator or time, a current running task ID, a mission completion indicator, a device arrival and a device dropout indicator. In further examples of the previous embodiment, the MM sends, to the XC, after completion of the task, a task resource release message to cause the XC to release the resources used to execute the task. In further examples of the previous embodiment, the XC sends, to the PFs and DPFs required to perform the task, after execution of the task, a PF/DPF resource release message to cause the PFs and DPFs to release the resources that were required to execute the task. In further examples of the previous embodiment, the PF/DPF resource release message includes an indicator bit. In further examples of the previous embodiment, the XC receives, from the PFs and DPFs, a resource release ACK message. In further examples of the previous embodiment, the XC receives, from the PFs and DPFs, a resource release ACK message.

In accordance with another embodiment of the present disclosure, there is provided a method, comprising, in communication network comprising a XaaS controller (XC), a radio access network (RAN), processing functions (PFs) and data plane functions (DPFs), the XC sending, to the RAN, a mission access invitation message. The RAN is configured to forward the mission access invitation message to the device. The mission access invitation message is configured to invite the device to access the mission. The XC receives, from the RAN, a mission access invitation ACK message indicating an acceptance of the device to access the mission. The XC enables communication between the device, the PFs and the DPFs.

### BRIEF DESCRIPTION OF THE FIGURES

Further features and advantages of the present invention will become apparent from the following detailed description, taken in combination with the appended drawings, in which:

FIG. 1 shows a block diagram of an embodiment of a mission and task architecture, in accordance with the present invention.

FIG. 2 shows a block diagram of an embodiment of a system in accordance with the present disclosure.

FIG. 3 shows a block diagram of an embodiment a management hierarchy for a mission manager, a XaaS service controller, processing functions and data plane functions in accordance with the present disclosure.

FIG. 4 shows a block diagram of another embodiment of a system in accordance with the present disclosure.

FIG. 5 shows an embodiment of a workflow of a mission execution procedure in accordance with the present disclosure.

FIG. 6 shows an embodiment of a workflow of a mission establishment procedure in accordance with the present disclosure.

FIG. 7 shows an alternative embodiment of a workflow of a mission establishment procedure in accordance with the present disclosure.

FIG. 8A shows an embodiment of a workflow of a XC selection and configuration procedure in accordance with the present disclosure.

FIG. 8B shows another embodiment of a workflow of a XC selection and configuration procedure, in accordance with the present disclosure.

FIG. 8C shows an embodiment of a process flow for executing a task of mission, in accordance with the present disclosure.

FIG. 9 shows an embodiment of a workflow of a procedure for a device to access a mission in an X-centric network, in accordance with the present disclosure.

FIG. 10 shows, in accordance with the present disclosure, an embodiment of a workflow of the procedure for selecting a serving MM for a device, when the mission to be accessed by the device has been established.

FIG. 11 shows, in accordance with the present disclosure, an embodiment of a workflow of a procedure for selecting the serving MM for a device, when the mission to be accessed by the device has not been established.

FIG. 12 shows, in accordance with the present disclosure, an embodiment of a workflow of a procedure for selecting a serving MM for a device 190, when the target mission execution can be triggered by the device.

FIG. 13 shows, in accordance with the present disclosure, an embodiment of a workflow of a procedure for a serving XC selection procedure.

FIG. 14 shows, in accordance with the present disclosure, an embodiment of a workflow of a procedure for a R2X interface buildup.

FIG. 15 shows an embodiment of a workflow of a procedure for accessing a device through a D2X interface, in accordance with the present disclosure.

It will be noted that throughout the appended drawings, like features are identified by like reference numerals.

### DETAILED DESCRIPTION

As used herein, the term “about” should be read as including variation from the nominal value, for example, a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

In the context of the present disclosure, an XaaS service is a type of network service which provides one or multiple data communication, data processing, or data computing functionalities. Typical XaaS services include NET4AI, NET4DATA, DAM, NET4BC, NET4META and various vertical applications (e.g., V2X, IoT). The XaaS service can be either a network-native service provided by a network provider, or a plug-in service provided by third parties. In some embodiments, the traditional 5G network is recognized as a special XaaS service providing connectivity.

In the context of the present disclosure, a mission is a procedure to achieve a goal (or to solve a problem) set by a network customer. A mission may comprise one or multiple tasks (or other reusable missions), which may be inter-dependent. A mission may involve tasks associated with heterogeneous XaaS services. For example, “to recognize photos with a cat from a massive number of photos” can be a mission which requires executions of a “data collection” task associated with DAM service, and a “NN (network native) training” task associated with NET4AI service.

In the context of the present disclosure, a task is a specific procedure or functionality to be executed to complete a mission. In an X-centric network, each task is associated with a XaaS service, and an execution of the task involves one or multiple processing functions (PFs), data plane functions (DPFs), device(s), and application servers (ASs), which may be inter-dependent. Each XaaS service can support one or multiple tasks.

In the context of the present disclosure, a device may be any terminal user equipment of the network such as, for example, a cellphone, a personal computer or a laptop, an IoT device like sensor, smart home devices, a vehicle connected to the vehicular network, an AR/VR (augmented reality/virtual reality) device, a satellite, etc. Any electrical device can be recognized as a device by the network.

In the context of the present disclosure, a processing function (PF) is a data plane function which sends, receives, and processes/computes data traffic, e.g. according to logics provided by the associated XaaS service. In an X-centric network, each PF is associated with a XaaS service, and each XaaS service has one or multiple associated PF(s). Each PF has an interface(s) (e.g. pre-defined by the associated XaaS service provider) to inter-communicate with other PF(s) associated with the same XaaS service, and an exposure interface(s) (e.g. pre-defined by the associated XaaS service provider) to inter-communicate with data plane function (DPFs) and XaaS service control functions. The PF(s) can connect with other PF(s) associated with different XaaS services via the DPF(s). A PF is a logical network function that may be instantiated or deployed at various network locations, e.g. an edge server, a cloud, a terminal device, or an application server (AS).

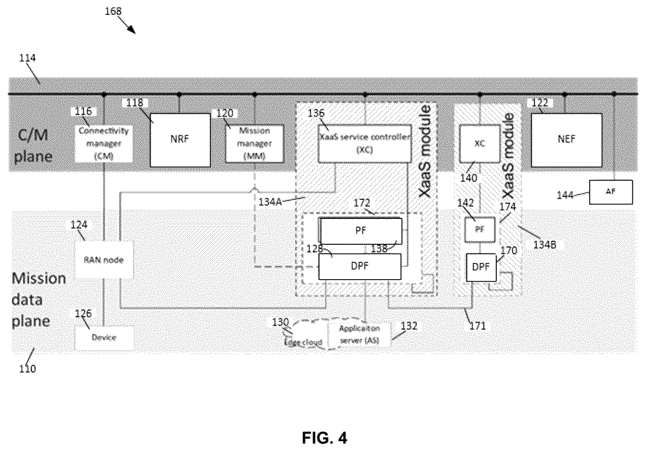

In the context of the present disclosure, a data plane function (DPF) is a function that provides communication or connectivity functionalities for data traffic, e.g., connecting an AS to the network, traditional user plane function (UPF) in 5G network. In an X-centric network, the DPF(s) can connect with other DPF(s) or PF(s) using exposure interface(s) via data plane links (e.g. logical tunnels). DPF(s) may be provided by the network (without being associated to any XaaS service) or may be provided by the associated XaaS service. A DPF is a logical network function; it can be instantiated or deployed at various network locations, e.g. an edge server, a RAN node, a cloud, a terminal device, an application server. In some embodiments, a PF (processing function) and a DPF within an XaaS service can be integrated into a single network entity (e.g., a XaaS data plane function (XDPF) such as shown at 172 in FIG. 4).

In the context of the present disclosure, a XaaS module is a module that offers or provides an XaaS service. The XaaS module includes PF(s)/DPF(s) and control functions that are needed to run/execute tasks associated with the XaaS service. Each XaaS module corresponds to a specific XaaS service. The XaaS module can be provided by the network (network-native XaaS module) or by third parties (plug-in XaaS module). Within each XaaS module, the associated PF(s)/DPF(s) (and the connected devices and ASs) form the XaaS service data plane (XSDP). Each XaaS module is associated with one or multiple XaaS service controllers (XCs), which implement control/management functionalities related to an execution of a task associated with the XaaS service (a.k.a. the XaaS module). In some embodiments, the data plane of a XaaS module includes of DPF(s) only (no PFs), and the XaaS service provided by the XaaS module may be a traditional connectivity service (e.g. connectivity service provided by a 5G network).

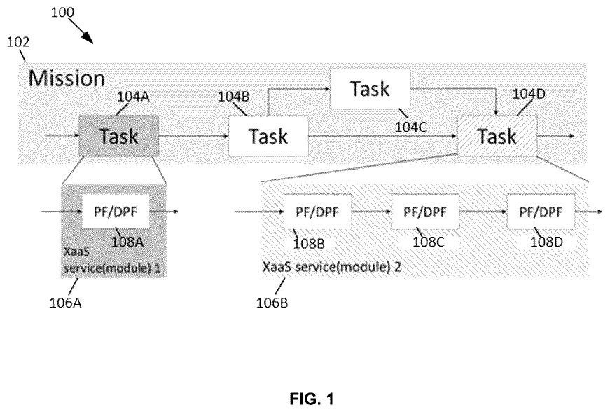

FIG. 1 shows a block diagram 100 of an embodiment of a mission and task architecture, in accordance with the present invention. The block diagram 100 shows a mission 102 that includes tasks 104A, 104B, 104C and 104D. The task 104A includes a XaaS module 106A, which includes a PF/DPF 108A. The task 104D includes a XaaS module 106B, which includes a PF/DPF 108B, a PF/DPF 108C and a PF/DPF 108D.

In the context of the present disclosure, a mission data plane (MDP) is associated with a mission and contains all PFs, DPFs, devices, ASs, and interfaces/links that interconnect them to execute specific steps or tasks within the mission. The MDP also contains all exposure control interfaces/links for the PFs, DPFs, devices, ASs, and interfaces/links to be managed by a corresponding XaaS service controller (XC). Each MDP may contain PF(s) and DPF(s) associated with one or multiple XaaS modules. A PF or DPF can be used/shared by or included in multiple MDPs. Each MDP is established/built up by the mission manager (MM) associated with the mission. For each MDP, the detailed data format, communication parameters and protocols, link topology of PF(s)/DPF(s) are all customized/determined or configured by the MM according to the associated mission's logic.

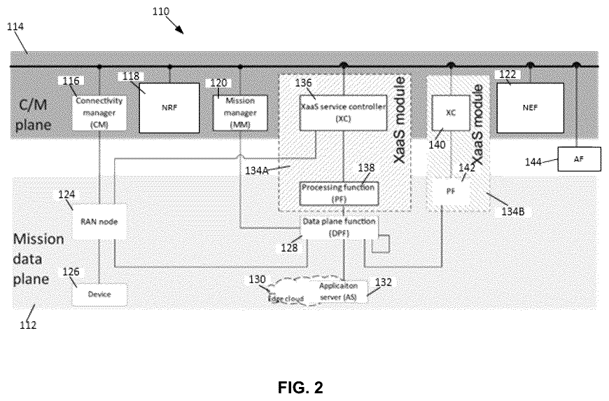

FIG. 2 shows a block diagram of an embodiment of a system 110 in accordance with the present disclosure. The system 110 may comprise a mission data plane 112 and a control/management (C/M) plane 114, which may include a connectivity manager 116, an X-centric network registry function (NRF) 118, a mission manager 120 and an X-centric network exposure function (NEF) 122. The mission data plane 110 may include a RAN node 124, a device 126, a DPF 128, an edge cloud 130 and an application server 132. The system 110 may include a XaaS module 134A that spans both the mission data plane 110 and the C/M plane 114. The XaaS module 134A may include a XaaS service controller (XC) 136 and a PF 138. The system 110 may also include another XaaS module 134B, which may include a XC 140 and a PF 142. Even though FIG. 2 shows two XaaS modules, the system 110 may include any suitable number of XaaS modules such as, for example, one XaaS module, two XaaS modules, or more than two XaaS modules. The system 110 may also have an application function (AF) 144 coupled to the C/M plane 114. The AF 144 is shown as being an external entity (outside the C/M plane 114) connected to the C/M plane 114. In other embodiments, the AF 114 may be an internal entity, comprised in the C/M plane 114. The AF 144 may be any suitable entity such as, for example, a cloud service, a mobile application server, a network resource management function, etc.

In the context of the present disclosure, a mission manager (MM) is a C/M plane function. Each mission may be associated with a MM which may schedule and coordinate execution of tasks in the mission, and the associated execution context. The MM establishes/builds up the MDP which is composed of PF(s)/DPF(s) associated with one or multiple XaaS modules; the MM manages/controls the execution of tasks of different XaaS services (supported by the PF(s)/DPF(s) in the MDP). In some embodiments, the MM can schedule/coordinate mission execution (i.e., the execution of task(s) comprised in the mission) and associated execution context by the pre-determined workflow/procedure (i.e., static mission management). In some embodiments, the MM may dynamically schedule/coordinate mission execution and associated execution context according to resource or network conditions, such as computing resource capacity and distribution, availability of required XaaS service functions, etc. (i.e., dynamic mission management). In some embodiments, the MM may be either centrally deployed in a network entity or deployed in multiple distributed entities.

In the context of the present disclosure, a XaaS service controller (XC) is a C/M plane function. Each XaaS service is associated with a XC which manages one or multiple tasks associated with the XaaS service. During the execution of a task, the associated XC schedules and coordinates execution of PF/DPF and the associated execution context (e.g., XaaS service dependent traffic steering), as well as the device/AS participation of the task. In some embodiments, the XC can schedule/coordinate task execution (and the associated execution context) and device/AS participation by a pre-determined workflow/procedure (i.e., static task management). In some embodiments, the XC can dynamically schedule/coordinate task execution (and the associated execution context) and device/AS participation according to resource or network conditions, such as computing resource capacity, availability of required devices/servers, traffic loads, etc. (i.e., dynamic task management).

The XC can be either centrally deployed in a network entity or be deployed in multiple distributed entities. In some embodiments, the XC can be organized in a hierarchical way where the upper layer central controller (UCF) conducts the global management functionalities of the XC to the XaaS service, e.g., interior configurations of PF/DPF provided by the XaaS service, XaaS service info/capability exposure to MM/network; The lower layer local controller (LCF) conducts task management functionalities of XC. Usually, the LCF may be distributed close to the PF/DPF managed by it.

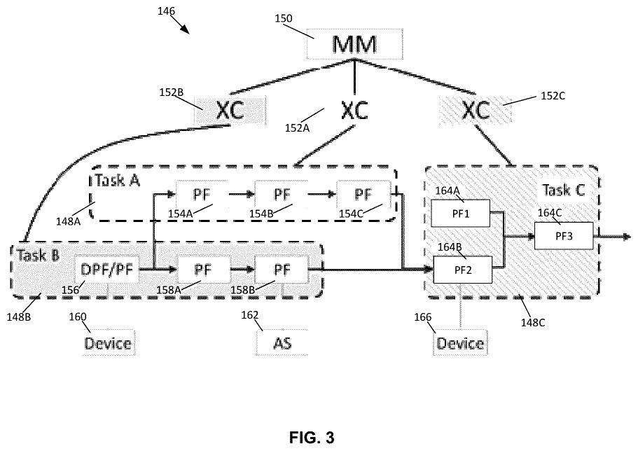

FIG. 3 shows a block diagram of an embodiment a MM, XC and PF/PFD management hierarchy 146 in accordance with the present disclosure, where three inter-dependent tasks, task 148A (Task A), task 148B (Task B) and task 148C (Task C) are managed by a MM 150 through a XC 152A, a XC 152B and a XC 152C. The XC 152A controls the task 148A, the XC 152B controls the task 148B and the XC 152C controls the task 148C. In this embodiment, the task 148 A includes a PF 154A, a PF 154B and PF 154C. The task 148B includes a DPF/PF 156, a PF 158A and a PF 158B. A device 160 is coupled to the DPF/PF 156. An AS 162 is coupled to the PF 158B. The task 148C includes a PF 164A, a PF 164B and a PF 164C. A device 166 is coupled to the PF 164B. Each XC (152A, 152B, 152C) is associated with a XaaS module. However, each XaaS module may comprise one XC or more than one XC.

In the context of the present disclosure, a connectivity manager (CM) is a C/M plane function which manages a device's access to the mission and involves in the device triggered mission execution.

In the context of the present disclosure, a XaaS network registry function (NRF) is a C/M plane function which stores and maintains the pre-determined information of PFs/DPFs, tasks and missions for mission execution.

In the context of the present disclosure, a XaaS network exposure function (NEF) is a C/M plane function which manages the interconnection among other entities/functions in the C/M plane (e.g., XC of a XaaS module, MM) and application functions (AFs).

In the context of the present disclosure, an application server (AS) may be required for processing or computing functions related to the execution of a task. As an example, an AS may be required for the joint classifier provided by a customer of automated vertical federated learning (VFL) service. An AS may be connected to a MDP by being connected to a DPF in the MDP.

In the context of the present disclosure, an application function (AF) may create a mission and trigger the mission execution.

FIG. 4 shows a block diagram 168 of another embodiment of a system of an X-centric network in accordance with the present disclosure. In this embodiment, the DPF 128 is provided in the XaaS module 134A and a DPF 170 is provided in the XaaS module 134B. The PF 138 and the DPF 128 may be integrated as a XaaS data plane function (XDPF) 172. The DPF 170 and the PF 142 may be integrated as another XDPF 174. Each XaaS module 134A and 134B may contain one XDPF or more than one XDPF. In the present embodiment, the XDPF 172 may be interconnected to the XDPF 173 via exposure interfaces on the XDPFs 172 and 174. An example of an exposure interface interfacing DPF 128 and DPF 170 (i.e., interfacing XDPF 172 and XDPF 174) is shown at reference number 171. Exposure interfaces may also be called inter-module interfaces. In some embodiments, the system 168 may include any suitable number of exposure interfaces interfacing XDPFs (or DPFs of XDPFs) of different XaaS modules. In some embodiments, the interface/connection between the MM 120 and the XDPFs is optional. Therefore, the MM 120 can configure DPF functionalities of a XDPF via the XC (136, 140) of the associated XaaS module (134A, 134B).

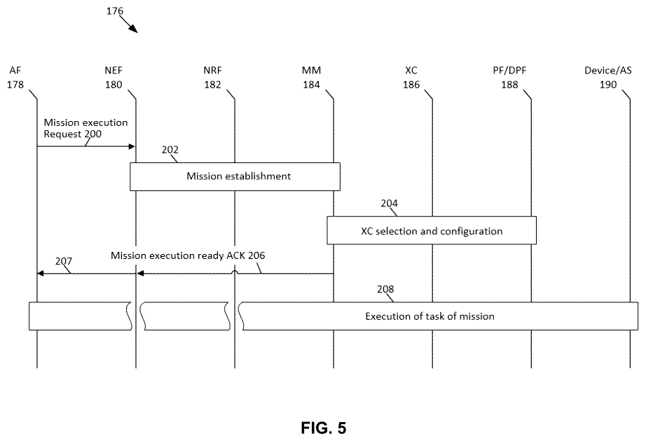

FIG. 5 shows an embodiment of a workflow (flow diagram) 176 in accordance with the present disclosure. The workflow 176 is that of a mission execution procedure. The mission execution procedure (the workflow 176) may be initiated by the AF 178 (or by a device), which may send, at action 200, a mission execution request message to the NEF 180 (or to a CM). After receiving the mission execution request, the NEF 180 (or CM) may conduct, at 202, a mission establishment procedure to select the MM 184 to manage the mission execution. The selected MM 184 may then establish/build up, with the NRF 182, a mission data plane in the mission establishment procedure. In this procedure, interactions between NRF 182, NEF 180 and the selected MM 184 are involved for the selected MM 184 to obtain the mission info and mission execution request which are further described below. Given the established mission data plane, the selected MM 184 may conduct, at 204, a XC selection and configuration procedure to select the XC 186 for a subset of PF(s)/DPF(s) 188 in the mission data plane to manage the execution of tasks involving the subset of PF(s)/DPF(s) 188. After completing the XC selection and configuration, the selected MM 184 may send, at 206, an ACK message (which indicates the mission is ready to be executed) to the NEF 180 (or CM), and the NEF 180 (or CM) may forward the message to the AF 178 (or device) initiating the mission execution. After all the previous steps, the tasks of the mission can be executed, at 208, by the corresponding PF(s)/DPF(s) according to their scheduled execution order and inter-dependency in the mission. The execution of tasks of the mission involves the interactions among the selected MM 184, the selected XC(s) 186, PF(s)/DPF(s) 188, device(s)/AS(s) 190, and the AF 178 (or device) initiating the mission execution.

According to embodiments of the present disclosure, in an X-centric network, a mission may be created by an application function (AF) or by an entity in the C/M plane, (the NEF in FIG. 2, or an XC in a XaaS module) during a mission provisioning stage. A mission may be described by its Mission information (data) (also known as mission info) which may include: (i) a mission identification (ID), (ii) information on the tasks comprised in the mission and their inter-dependency, (iii) ingress/egress points (can be comprising tasks) of the mission for data input/output, (iv) information on application servers (ASs) involved in the mission, e.g., IDs, names, addresses, and their participation points (can be comprising tasks of the mission, or ingress/egress points of reusable mission comprised in the mission), (v) device access requirements, e.g., allowed devices (or device groups), participation points of the mission, device access constraints (e.g., computing capacity constraints, maximal device number constraints, behavior constraints). After the creation of a mission, the mission info generated in during the mission provisioning stage may be stored by the X-centric network (e.g., in the NRF in some embodiments), then published to devices through CM, and to AF through NEF. Given the mission info generated during the mission provisioning stage, the detailed procedure of the mission execution workflow 176, triggered by the AF 178, may be described as comprising a mission execution triggering (200), a mission establishment (202), a XC selection and configuration (204), a sending of a mission execution ready ACK message (206), and an execution of the mission (208).

Mission execution triggering 200. The execution of a mission may be triggered by the AF 178. To trigger a mission execution, the mission execution request (MER) message may be sent from the AF 178 to the NEF 180 first. The contents of MER message may include:
The requested mission ID, and
Additional requirements for mission execution not indicated in mission info, e.g., maximal execution time constraint, minimal computing/networking resources requirements. In some embodiments, the additional requirements can be void in the MER.

Mission establishment 202. After having received the MER message sent by the AF 178 at action 200, the NEF 180 may conduct the mission establishment procedure 202 to select the MM 184, which manages the mission execution. The selected MM 184 may further establish the mission data plane (MDP) for the mission.

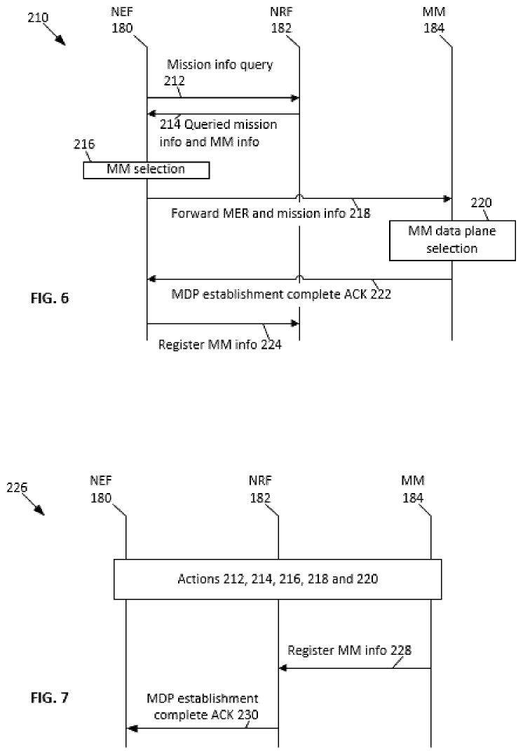

FIG. 6 shows an embodiment of a workflow (flow diagram) 210 of a mission establishment procedure in accordance with the present disclosure.

At 212, the NEF 180 may send a query message to the NRF 182 (which stores and maintains all mission info generated in mission provisioning stage) to query the mission info of the requested mission in the MER. As the response to the query message, the NRF 182 may send to the NEF 180, at 214, a response message containing the corresponding mission info queried by the NEF 180. In some embodiments where the NEF 180 has no information of MMs in the X-centric network, the NRF 182 may add the MM info (of all MMs in the X-centric network) in the mission info response message sent to the NEF 180 at 214. For each MM, the MM info may include:
The MM ID
Serving area of the MM, which may be represented by/associated with the set of PF(s)/DPF(s) that may be managed by the MM
The MM location/address
Capacity of the MM, including computing capacity, maximal number of missions to be managed simultaneously, maximal number of PF(s)/DPF(s) that can be managed in a mission, etc.
Current loads on the MM entities, including data traffic loads of the entities, computing loads of the CPU/GPU on the entities, etc.

Given the received mission info (and MM info) in the response message sent by the NRF 182 action 214, the NEF 180 may select, at 216, a MM as the selected MM 184 to manage the execution of the mission. The MM selection criteria may include a MM service area, an AS location, a device location, a capacity of the MM, current loads on the MM entities, etc.

To establish the MDP, after the NEF 180 completes MM selection at 216, the NEF 180 may send to the MM 184, at 218, a MDP establishing message containing both the MER message contents and the mission info received at 214.

Subsequently, the selected MM 184 may establish the MDP for the mission based on the contents in the MDP establishing message.

In some embodiments, the MDP can be fully established and configured by the selected MM 184 before mission execution, which is referred to as static mission establishment. In some embodiments, the MDP may be incrementally established and configured by the selected MM 184 as tasks of the mission being executed, which is referred to as dynamic mission establishment.

After the selected MM 184 completes initial MDP establishment, i.e., after completion of a static mission establishment or completion of a dynamic mission establishment, the selected MM 184 may send, at 222 MDP an establishment complete ACK message to NEF 180.

After receiving the MDP establishment complete ACK message sent by the selected MM 184 at 222, the NEF 180 may send, at 224, a message containing the selected MM info (ID and address/location) to the NRF 182 for registration.

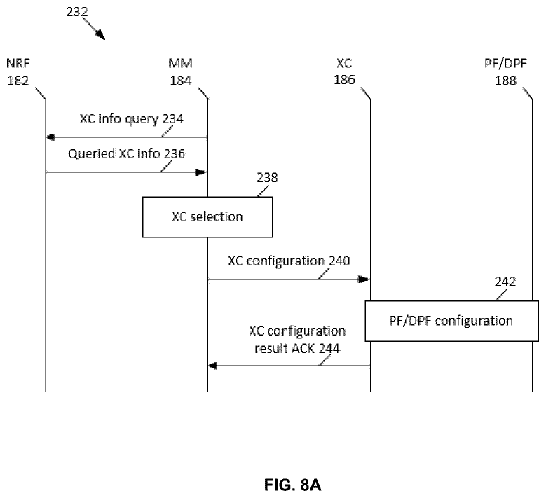

FIG. 7 shows an alternative embodiment of a workflow (flow diagram) 226 of a mission establishment procedure in accordance with the present disclosure.

In the workflow 226 of FIG. 7, the actions 212, 214, 216, 218 and 200 of the workflow 210 of FIG. 6 may be carried out. However, after action 220, in accordance with the workflow 226, the MM 184 may send, at 228, a message containing the selected MM info (ID and address/location) to the NRF 182 for registration. Subsequently, the NRF 182 may sends, at 230, a MDP establishment complete ACK message to NEF 180.

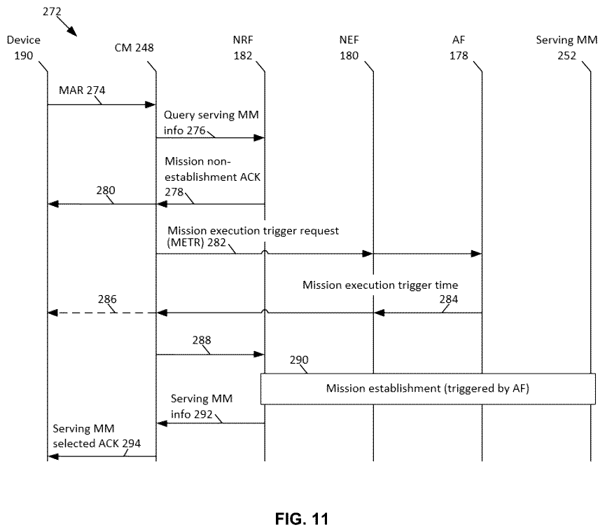

As a device may only trigger a mission execution when the mission accessed by the device is not established, the mission execution procedure triggered by a device is described further below in relation to FIG. 12.

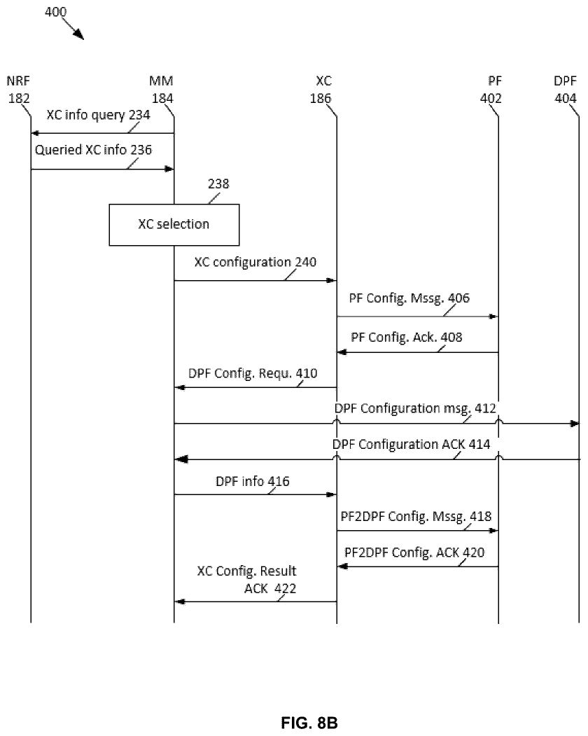

XC selection and configuration 204. Referring to FIG. 5, after completing the mission establishment 202 (after sending MDP establishment complete ACK for the selected MM 184), the selected MM 184 may conduct the XC selection and configuration 204. FIG. 8A shows an embodiment of a workflow (flow diagram) 232 of a XC selection and configuration procedure in accordance with the present disclosure.

XC info query. At action 234, the selected MM 184 may send a query message to the NRF 182, the query message may contain the description of the intention of the MM 184; the intention may be to query info of all available XC(s) within the serving area of the selected MM 184. After receiving the query message, The NRF 182 may send, at 236, a response message to the selected MM 184. The response message may contain the corresponding XC(s) info queried by the selected MM 184. The XC info for each XC may include:
XC location
Associated XaaS service/module
Serving area of the XC, which may be represented by/associated with the set of PF(s) or DPF(s) in the MDP that can be managed by the XC
XC capacity, including computing capacity, maximal number of PFs/DPFs to be managed simultaneously, etc.
Current computing and traffic loads on the XC entities, including data traffic loads of the entities, computing loads of the CPU/GPU on the entities, etc.

At action 238, using the XC info received at 236, the selected MM 184 may select an appropriate XC for each PF/DPF 188 in the MDP to manage the execution of the associated task. In some embodiments, the XC selection 238 may be completed at once, which is referred to as static XC selection. In some embodiments, the XC selection 238 may be incrementally conducted task by task as the mission executes, which is referred to as dynamic XC selection. Apart from the XC info received by the MM 184 at action 236, other XC selection criteria may include: whether the associated XaaS module of the XC 186 can support the task to be managed by the XC 186, the location of PF(s)/DPF(s) 188 associated with the task to be managed by the XC 186, the location(s) of AS(s) and device(s) involved in the task to be managed by the XC 186, etc.

XC configuration. At action 240, the selected MM 184 may send a XC configuration message to each selected XC 186. The XC configuration message may contain the info of the PF(s)/DPF(s) 188 managed by the selected XC 186 (e.g., the info may include the exposed control interface address of the PF(s)/DPF(s) 188).

PF/DPF configuration. After receiving the XC configuration message from the selected MM 184, each selected XC 186 may send, at action 242, a PF/DPF configuration message to each PF/DPF 188 indicated in the XC configuration message. The PF/DPF configuration message may contain the ID of the selected XC 186 sending the message, and optional detail configurations including maximal computing resource usage on the PF/DPF for executing the task, etc. In some embodiments, the PF/DPF 188 receiving the PF/DPF configuration message may send an ACK message to the selected XC 186, the ACK message may cause an activation of a control interface/link between XC 188 and the PF/DPF. The ACK can be as simple as one bit signal to confirm the reception of the PF/DPF configuration message.

After completing PF/DPF configuration procedure, the selected XC 186 may sends, at action 244, a XC configuration complete ACK message to the selected MM 184 to indicate the completion of XC selection and configuration procedure.

FIG. 8B shows another embodiment of a workflow (flow diagram) 400 of a XC selection and configuration procedure in accordance with the present disclosure.

XC info query. At action 234, the selected MM 184 may send a query message to the NRF 182, the query message may contain the description of the intention of the MM 184. The intention may be to query info of all available XC(s) within the serving area of the selected MM 184. After receiving the query message, The NRF 182 may send, at 236, a response message to the selected MM 184. The response message may contain the corresponding XC(s) info queried by the selected MM 184. The XC info for each XC may include:
XC location
Associated XaaS service/module
Serving area of the XC, which may be represented by/associated with the set of PF(s) or DPF(s) in the MDP that can be managed by the XC
XC capacity, including computing capacity, maximal number of PFs/DPFs to be managed simultaneously, etc.
Current computing and traffic loads on the XC entities, including data traffic loads of the entities, computing loads of the CPU/GPU on the entities, etc.

At action 238, using the XC info received at 236, the selected MM 184 may select an appropriate XC for each PF 402 and DPF 404 in the MDP to manage the execution of the associated task. In some embodiments, the XC selection 238 may be completed at once, which is referred to as a static XC selection. In some embodiments, the XC selection 238 may be incrementally conducted task by task as the mission executes, which is referred to as a dynamic XC selection. Apart from the XC info received by the MM 184 at action 236, other XC selection criteria may include: whether the associated XaaS module of the XC 186 can support the task to be managed by the XC 186, the location of the PF(s) 402 and the DPF(s) 404 associated with the task to be managed by the XC 186, the location(s) of AS(s) and device(s) involved in the task to be managed by the XC 186, etc.

XC configuration. At action 240, the selected MM 184 may send a XC configuration message to each selected XC 186. The XC configuration message may contain the info of the PF(s) 402 and of the DPF(s) 404 managed by the selected XC 186 (e.g., the info may include the exposed control interface address of the PF(s) 402 and of the DPF(s) 404). In some embodiments, the selected MM 184 may only indicate the description(s) of functionalities to be instantiated by the PF(s) 402. The XC 186 can further analyze the description(s) and determine detailed PF(s) 402 with their inter-dependency and the execution according to the pre-defined internal intelligence/knowledge in the XC 186.

PF configuration. After receiving the XC configuration message from the selected MM 184, each selected XC 186 sends, at action 406, a PF configuration message to each PF 402 indicated in the XC configuration message. The PF configuration message contains the ID of the selected XC 186 sending the message, and optional detailed configurations including maximal computing resource usage by the PF 402 for executing the task, etc. In some embodiments, the PF 402 receiving the PF configuration message may send, at action 408, a PF configuration ACK message to the selected XC 186 that sent the PF configuration message to activate the control interface/link between the XC 186 and the PF 402.

DPF configuration. Given the configured PF(s) 402, the selected XC 186 may send, at action 410, a DPF configuration request to the selected MM 184 to configure the required DPF(s) 404. The contents of the DPF configuration request include the address(es) of exposed PF(s) 402 in the XaaS module. The exposed PF(s) 402 indicate the PF(s) 402 (in a XaaS module) to be connected with the DPF(s) 404.

DPF configuration. After receiving the DPF configuration request from the selected XC 186, the selected MM 184 sends, at action 412 a DPF configuration message to the corresponding DPF(s) 404 in the MDP, the DPF configuration message contains the address(es) of exposed PF(s) 402 to be connected with the DPF 404, and optional detail configurations including maximal computing resource usage by the DPF 404 for executing the task, data throughput range for the task through the DPF, etc. In some embodiments, the DPF 404 receiving the DPF configuration message may send, at action 414, a DPF configuration ACK message to the selected MM 184 to activate the control interface/link between the MM 184 and the DPF(s)_404.

DPF info sharing. The selected MM 184 may send, at action 416, DPF info (data) to the selected XC 186 to share the interface info of the configured DPF(s) 404 with the selected XC 186. The contents of the DPF info may include the configured DPF(s)' interface address(es) to the corresponding PF(s) 402 to be connected.

PF2DPF configuration. After receiving the DPF info from the selected MM 184, each selected XC 186 may send, at action 418, a PF to DPF (PF2DPF) configuration message to the corresponding PF(s) 402 to configure the exposed control interface between the PF(s) 402 and the DPF(s) 404. The PF2DPF configuration message may contain the configured DPF(s)' interface address(es) to the corresponding PF(s) 404. In some embodiments, the PF 402 receiving the DPF configuration message may send, at action 420, a PF2DPF configuration ACK to the selected XC 186 that sent the PF2DPF configuration message.

After completing the PF/DPF configuration procedure, the selected XC 186 may send, at action 422, a XC configuration result ACK to the selected MM 184 to indicate the completion of the XC selection and configuration procedure.

Mission execution ready ACK. Referring back to FIG. 5, after completing the XC selection and configuration 204, the selected MM 184 may send a mission execution ready ACK message 206 to the NEF 180, the message may be a signal (or contain a description) that indicates the tasks in the mission is ready to be executed. After receiving the mission execution ready ACK message 206, the NEF 180 may forward, at 207, the mission execution ready ACK message to the AF 178 to initiate the mission execution.

The execution of a mission is gradually conducted by the execution of tasks comprised in the mission. The executions of tasks (of the mission) may be conducted sequentially or in parallel, according to the mission execution logic and inter-dependency between tasks (which are pre-determined in mission info). FIG. 3 shows an example workflow of a mission execution where task 148A and task 148B are executed in parallel, and are then followed the execution of task 148C.

To manage the task execution and associated execution context in the mission, the behaviors conducted or initiated by the selected MM 184 during the execution of task of the mission may include the following:
Trigger task execution: the selected MM 184 may send a task trigger message to the selected XC 186 managing the task to be triggered. The task trigger message may include the task ID and the scheduled start time of the task execution.
In some embodiments where dynamic XC selection is applied, the selected MM 184 may first conduct a XC selection and configuration procedure for the task to be triggered, then, conduct a trigger task execution procedure.
In some embodiments where dynamic mission establishment is applied, the selected MM 184 may first conduct a mission establishment procedure to establish the partial MDP for the task to be triggered, then, conduct a XC selection and configuration procedure for the task to be triggered, then, conduct a trigger task execution procedure.
Manage task execution: in some embodiments, the selected MM 184 may monitor the current running task(s) and coordinate the selected XC(s) behaviors by sending task management message(s) to the corresponding XC(s). The contents of the task management message may include: a task suspension signal, a task waiting time to start, a resource utilization constraint for parallel running tasks, etc. In some embodiments, the selected MM 184 may modify the current MDP according to load balancing constraints or XC/device requests.
Notify AF: in some embodiments, the selected MM 184 may periodically (or on pre-defined time slots) send a notification message, i.e., a mission status message, to the AF 178 initiating the mission execution. The contents of the notification message may include: a mission start indicator or time, a current running task ID, a mission completion indicator, a device arrival/dropout indicator, a mission execution result, etc.
Release task resources: in some embodiments, the selected MM 184 may monitor the task execution complete message sent from the selected XC(s). After receiving the task execution complete message, the selected MM 184 may release the corresponding resources (computing and communication resources) for the task managed by the selected XC sending the task execution complete message.

For each task, the task execution may be gradually conducted by the data sending, receiving and processing/computing behaviors running on the PF(s) and DPF(s) comprised in the task. The running of PF(s)/DPF(s) may be sequential or parallel according to the task execution logic and inter-dependency between PF(s)/DPF(s) (which are pre-determined in the task info). In FIG. 3, PF 164A and PF 164B of task 148C are running in parallel, then follows PF 164C.

To manage the execution of the associated task, the behaviors conducted by the selected XC 186 during the task execution may include:
After receiving the task trigger message sent from the selected MM 184, the selected XC 186 may send a message, i.e., a PF trigger message, to the corresponding PF(s)/DPF(s) 188 to execute their corresponding steps of the task. The contents of the message may include: scheduled start time(s) to execute corresponding step(s) of the task, resource utilization constraints to execute corresponding step(s) of the task, etc.
The selected XC 186 may send an invitation message to invite devices to access the mission. Details of the invitation message are provided further below.
The selected XC 186 may send a notification message to the DPF 188 connecting to the AS 190 to be invited to join the mission execution. The DPF 188 may then forward the notification message to the AS 190 to be invited to join the mission execution. In some embodiments where only the AF 178 can notify the AS 190 to run, the selected XC 186 may send the notification message to NEF 180, then the NEF 180 may forward it to the corresponding AF 178, which may notify the AS 190.
Manage PF/DPF execution: the selected XC 186 may monitor the current running PF(s)/DPF(s) 188 and coordinate their behaviors by sending PF/DPF management message(s) to the corresponding PF(s)/DPF(s) 188. The contents of the PF/DPF management message may include: a PF/DPF running suspension signal, a PF/DPF waiting time to start, resource utilization constraints for parallel running of PFs/DPFs 188, etc.
In some embodiments, the selected XC 186 may send MDP modification request message to the selected MM 184 to re-select the associated PF(s)/DPF(s) 188 due to load balancing or device access impacts.
Notify the selected MM: the selected XC 186 may periodically (or on pre-defined time slots) send a notification message, i.e., task status info, to the selected MM 184. The contents of the notification message may include: a task start indicator or time, a task execution complete message (as described in previous paragraph), a device arrival/dropout indicator, a task execution result, etc.
Receive the step/work complete message(s), i.e., PF/DPF complete message(s), sent by PF(s)/DPF(s) 188 indicating the completion of the PF(s)/DPF(s) running.

FIG. 8C shows a process flow 405 for an embodiment of a procedure of executing a task of a mission, in accordance with the present disclosure. At action 450, the MM 184 sends a task trigger message to the XC 186, which manages the task to be triggered. The task trigger message may include the task ID and a scheduled start time of the task execution. In some embodiments where dynamic XC selection is applied, the selected MM 184 can first conduct a XC selection and configuration procedure for the task to be triggered, and then proceed with sending the task trigger message to the XC 186.

In some embodiments where dynamic mission establishment is applied, the MM 184 can first conduct mission establishment procedure to establish the partial MDP for the task to be triggered, then, conduct a XC selection and configuration procedure for the task to be triggered, and then proceed with sending the task trigger message to the XC 186.

The task execution procedure then proceeds to action 452, to cause the PF/DPF 188 to execute. The execution of the PF/DPF 188 may include action 454 where the XC 186 sends a PF/DPF trigger message to the PF/DPF 188 to execute their corresponding steps of the task. The contents of the PF trigger message may include scheduled start time(s) to execute corresponding step(s) of the task, resource utilization constraints to execute corresponding step(s) of the task, etc.

The executing/running PF/DPF 455 may periodically (or on pre-defined time slots) sends, at action 456, a notification message, i.e., PF/DPF status info, to the selected XC 186 for the selected XC 186 to monitor its status. The contents of the PF/DPF status info may include a task start indicator or time, task execution complete message, device arrival/dropout indicator, etc.

At action 458, the XC 186 may send a PF/DPF management message to the executing/running PF/DPF 455. That is, the selected XC 186 monitors the current running PF(s)/DPF(s) and coordinates their behaviors by sending PF/DPF management message(s) to the corresponding executing/running PF(s)/DPF(s) 188. The contents of the PF/DPF management message may include a PF/DPF running suspension signal, a PF/DPF waiting time to start, resource utilization constrains for parallel running of PFs/DPFs, etc.

At action 460, the PF/DPF 188 may send a PF/DPF complete message to the XC 186 to notify the XC 186 that the PF/DPF 188 have finished executing/running. In some embodiments where multiple PFs/DPFs 188 are involved in one task, the PF/DPF execution procedure for each PF/DPF may be conducted sequentially or parallelly according to the executing schedule defined in MDP or scheduled by the selected XC 186 of the corresponding XaaS module. Note that the action 455 executed by PF/DPF 188 may be executed multiple times in a mission according to the PF/DPF management message(s) sent by XC 186. The action 455 executed by some PF/DPF 188 may also be executed in parallel with another action 455 executed by other PF/DPF according to the pre-defined PF/DPF management message(s) sent by XC 186.

The selected XC 186 may periodically (or on pre-defined time slots) send, at action 464, task status info to the selected MM 184. The contents of the notification message may include: task start indicator or time, task execution complete message, device arrival/dropout indicator, etc. The task status info may be sent, at action 464, during the execution of a PF/DPF managed by the selected XC 186. Alternatively, the task status info may be sent, at action 466, after the PF/DPF managed by the selected XC 186 completed the execution, or, at action 468, after the last PF/DPF of the task been completed. The task status info sent at action 468 should preferably contain the task execution complete message to trigger the task resource release procedure described elsewhere in the present disclosure.

At action 465, the XC 186 may send, to the MM 184, a MDP modification request message to cause the MM 184 to reselect PFs/DPFs if the current PFs/DPFs 188 cannot ensure the requirements of the task or mission (e.g., minimal computing resources).

At action 467, the MM 184 may send to the XC 186 a task management message. The contents of the task management message may include: a task suspension signal, a task waiting time to start, a resource utilization constraint for parallel running tasks, etc. In some embodiments, the selected MM 184 may modify the current MDP according to the MDP modification request message received from XC 186, at action 465.

At action 470, the MM 184 may send, during the execution of a task, a mission status message to the AF 178. At action 472, the MM 184 may also send, after the execution of a task, a mission status message to the AF 178. That is, the selected MM 184 may periodically (or on pre-defined time slots) send a mission status message to the AF 178 that initiated the mission execution. The contents of the notification message may include: a mission start indicator or time, current running task ID, mission completion indicator, device arrival/dropout indicator, etc.

Task resource release: After receiving the task status info from the selected XC 186, the selected MM 184 releases the corresponding resources (computing and communication resources) for the task, and sends, at action 474, a task resource release message to the XC 186. The task resource release message may be, in some embodiments, as short as an indicator bit. Upon receiving the task resource release message, the selected XC 186 releases the corresponding resources (computing and communication resources) for the task and sends, at action 476, a PF/DPF resource release message to the PF/DPF 188 involved in the task. The PF/DPF resource release message can be as short as an indicator bit. Upon receiving the PF/DPF resource release message, the PF/DFP 188 releases the corresponding resources (computing and communication resources) for the task and sends, at action 478, to the XC 186, a PF/DPF resource release ACK. After receiving the PF/DPF resource release ACKs from all involved PF(s)/DPF(s) 188, the selected XC 186 sends, at action 480, a resource release ACK to the selected MM 184 to complete the task resource release procedure. Generally, the selected MM 184 monitors the task execution complete message sent from the selected XC(s) 186. After receiving the task execution complete message (task status info message that indicates the task has completed—see action 468), the selected MM 184 release the corresponding resources (computing and communication resources) for the task managed by the selected XC 186 that sent the task execution complete message at action 468.

In some embodiments where the DPF can only be configured by the selected MM 184, the PF/DPF resource release message to the DPF(s) should be sent by the selected MM 184 to the involved DPF(s). In these embodiments, the DPF(s) may send PF/DPF resource release ACK to the selected MM 184.

In some embodiments of the present disclosure, a device may perform as a PF to conduct some processing steps in its accessed task of the mission and be coordinated/managed by the selected XC managing the accessed task. Therefore, to perform as a PF in the mission, the device may need to access to a specific task by connecting the device to the XC managing the task and the data plane executing the task. This procedure is defined as mission access procedure.

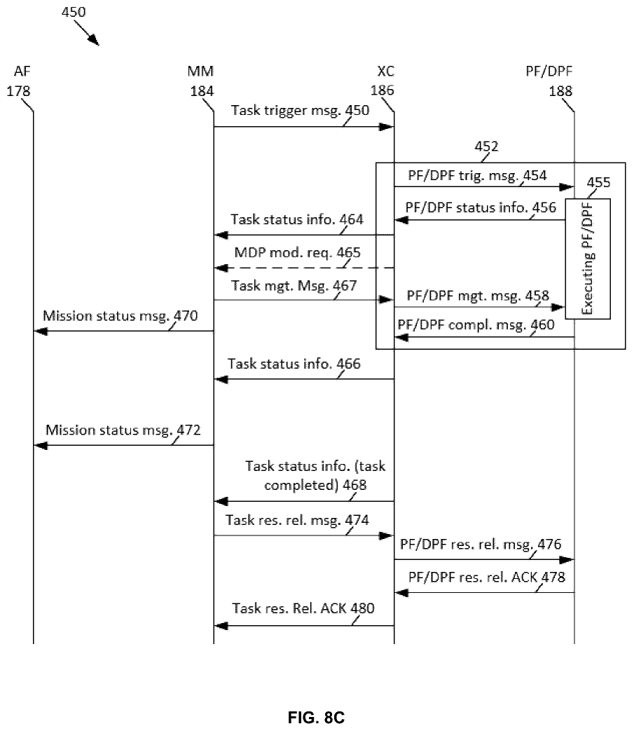

FIG. 9 shows an embodiment of a workflow (flow diagram) 246 of a procedure for a device 190 to access a mission in an X-centric network, in accordance with the present disclosure. The mission access procedure may be initiated by a device 190 which may send a mission access request message, via the RAN node 124, to the CM 248. After receiving the mission access request message, the CM 248 may conduct, at action 250, a serving MM selection procedure to select the serving MM 252, which manages the mission to be accessed by the device 190. If the mission to be accessed by the device 190 has not been established, the CM 248 may first trigger a mission establishment procedure, (described above in relation to, for example, FIGS. 6 and 7) for the mission to be accessed by the device 190, and then proceed with action 250. After the serving MM selection procedure, the selected serving MM 252 may conduct, at action 254, a serving XC selection procedure to select a serving XC 256 to manage the task (of the mission) to be accessed by the device 190. By completing the serving XC selection procedure, the CM 248 may establish, at action 258, the RAN node 124 to a serving XC (R2X) interface for the control of signal transmission between the serving XC 256 and the device 190. The access by the device 190 to the service XC 256 is represented by the arrow 260. Subsequently, the serving XC 256 may send an invitation message to invite the device 190 to join the data plane of the task via the R2X interface, thereby completing the mission access procedure.

Serving MM selection: The serving MM selection procedure 250 may be initiated by the device 190 sending a mission access request to the CM 248. Detailed procedures for the CM 248 to select serving MM 252 may be different according to different scenarios, such as, for example: 1) the mission to be accessed by the device 190 has been established, 2) the mission to be accessed by the device 190 has not been established and the mission establishment must be triggered by an AF 178, 3) the mission to be accessed by the device 190 has not been established and the mission establishment may be triggered by the device 190.

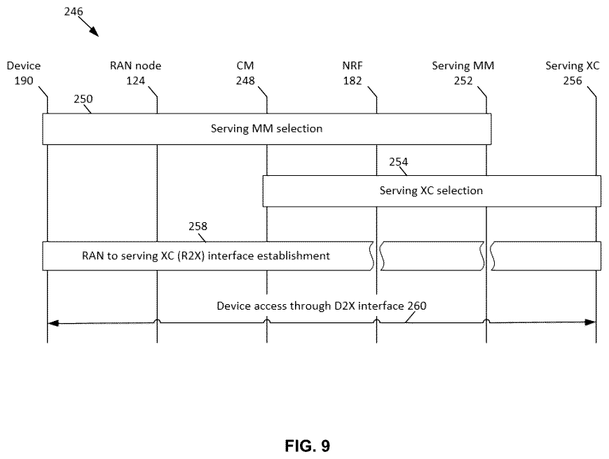

FIG. 10 shows, in accordance with the present disclosure, an embodiment of a workflow (flow diagram) 262 of the procedure for selecting the serving MM for the device 190 shown at action 250 of FIG. 9, when the mission to be accessed by the device 190 has been established.

To access a mission, the device 190 may send, at 264, a mission access request (MAR) message to the CM 248 (mission info has been published to the device 190 during mission information provision stage), the contents in the MAR message is the MAR info, which may include:
Target mission ID
Device info, including device type, maximal available time to access the mission, security/privacy requirements (e.g., UE customized data access constraints), resource usage limitation, etc.
Device requests (to the mission), including intention/purpose to access the mission (can be translated to some processing steps of a comprising task), expected mission start time, participant point (task) of the mission, minimal data rate/maximal delay thresholds for device to PF/DPF data transmission, etc.

After receiving the MAR message, the CM 248 may send, at action 266, a query message to the NRF 182 to request the serving MM 252 info on the target mission. The contents of the query message may include the target mission ID.

If the target mission has been established, the NRF 182 may send, at action 268, a response message to the CM 248. The response message may contain the ID and location/address of the MM which manages the target mission.

After receiving the response message sent by the NRF 182, the CM 248 may select the MM managing the target mission as the serving MM, and send, at action 270, a serving MM selected ACK message to the device.

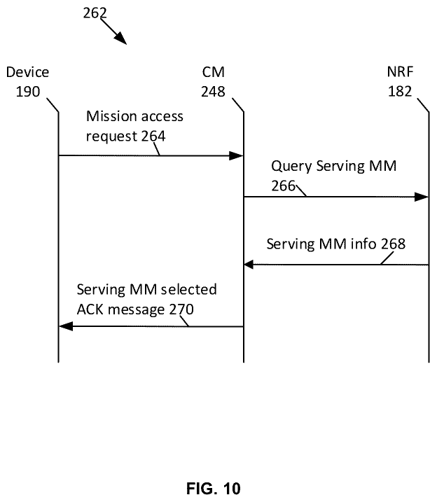

FIG. 11 shows an embodiment of a workflow (flow diagram) 272 of a procedure for selecting the serving MM 252 for the device, when the mission to be accessed by the device 190 has not been established and the target mission establishment must be triggered by an AF (as pre-determined in mission info). In this scenario, the serving MM selection procedure may include the following.

At action 274 of the workflow 272, the device 190 may send an MAR message to the CM 248.

After receiving the MAR message, the CM 248 may send, at 276, a query message to the NRF 182 to request serving MM info of the target mission. The contents of the query message may include the target mission ID.

If the target mission has not been established and the target mission execution must be triggered by an AF 178, the NRF 182 may send, at 278, a mission non-establishment ACK message to the CM 248. The mission non-establishment ACK message may contain the ID and location/address of the AF 190, which can trigger the target mission establishment. At action 280, the CM 248 may forward the mission non-establishment ACK message to the device 190 (in some embodiments, the mission non-establishment ACK message forwarded to the device by the CM 248 can delete the ID and location/address of the AF which can trigger the target mission establishment).

The CM 248 may send, at action 282, a mission execution trigger request (METR) message to the AF 178 (via the NEF 180), which may trigger the target mission establishment. In some embodiments, the METR message may contain the device's requests to mission execution, which are indicated in MAR (e.g., expected mission start time).

After receiving the METR message, which can trigger the target mission establishment, the AF 178 may send, at action 284, a message containing the scheduled mission execution triggering time (METT) to the CM 248. After receiving the message containing METT, the CM 248 may send, at 286, a message to the device 190, the message may contain the METT information as an ACK signal to the device's MAR.

After receiving the message containing METT, the CM 248 may send, at 288, a message to the NRF 182, the message containing the request to subscribe the selected MM info of the target mission from the NRF 182.

The AF 178 may subsequently conduct the mission establishment procedure at action 290.

After initiation of the mission establishment procedure by the AF 178 is complete, the NRF 182 may send, at 292, a message to the CM 244, the message may contain the ID and location/address of the selected MM managing the target mission.

After receiving the message sent by the NRF 182, the CM 248 may select the selected MM in the mission establishment procedure as the serving MM 252, and may send, at action 294, a serving MM selected ACK message to the device 190.

FIG. 12 shows an embodiment of a workflow (flow diagram) 295 of a procedure for selecting the serving MM for the device 190 shown at action 250 of FIG. 9, when the target mission execution can be triggered by the device 190. In this scenario, the serving MM selection procedure may include the following.

At action 296, the device 190 may send a MAR message to CM 248.

After receiving the MAR message, the CM 248 may send at 298, a query message to the NRF 182 to request serving MM info of the target mission. The contents of the query message may include the target mission ID.

If the target mission has not been established, and the target mission execution must be triggered by an AF, then the NRF 182 may sends at 300, a mission non-establishment ACK message to the CM 248. The message may contain the ID and location/address of the AF which can trigger the target mission establishment. The CM 248 may forward, at action 301, the mission non-establishment ACK message to the device 190 (in some embodiments, the mission non-establishment ACK message forwarded to the device by the CM 248 can delete the ID and location/address of the AF, which can trigger the target mission establishment).

After receiving the mission non-establishment ACK message, the CM 248 may conduct, at 302, the mission establishment procedure, an example of which is described above in relation to action 202 of FIG. 5. In this case (mission establishment triggered by device), the NEF 180 in the mission establishment procedure described in relation to FIG. 5 is replaced by the CM, and the MER in the mission establishment procedure described above in relation to action 202 of FIG. 5 is replaced by the MAR.

After completing the mission establishment procedure, the CM 248 selects the selected MM in the mission establishment procedure as the serving MM 252, and sends, at 304, a serving MM selected ACK message to the device 190.

Serving XC selection: After completing the serving MM selection procedure, the serving MM 252 may further select the serving XC which manages the task (participant point) for device to access. In some embodiments where the serving MM has not conducted the XC selection and configuration procedure (see example at FIG. 8A), the XC selection and configuration procedure must be conducted first before conducting serving XC selection procedure.

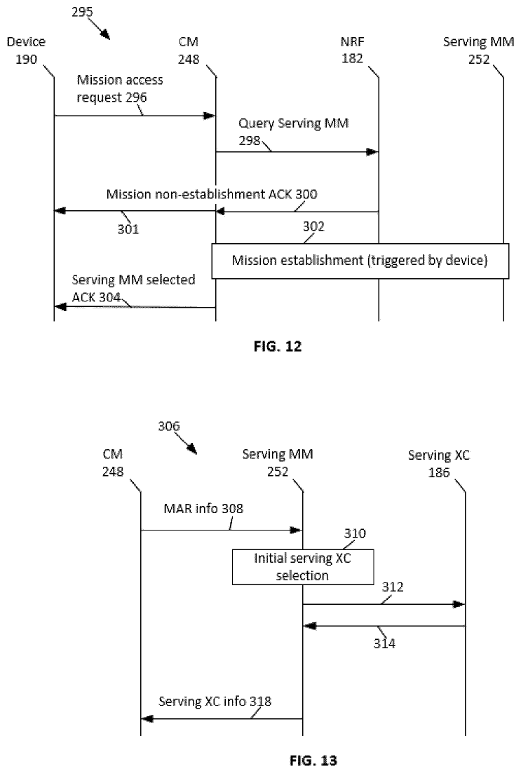

FIG. 13 shows an embodiment of a workflow (flow diagram) 306 of a procedure for a serving XC selection procedure, which may include the following.

The CM may send, at 308, a message to the serving MM 252 to initiate the serving XC selection. The contents of the message may include the MAR info.

After receiving the message, the serving MM 252 may conduct, at action 310, an initial serving XC selection based on following criteria:
If the participant point (i.e., the exact task of the mission where the device should access) is specified in the MAR info, the serving MM 252 may select the corresponding XC managing the task (participant point) as the serving XC.
If the participant point is not specified in the MAR, the serving MM 252 may first translate the device's intention/purpose to access the mission (indicated in MAR) to the processing steps of a comprising task, then select the XC which manages the task covering the device intention/purpose as the serving XC.
For multiple devices with a same intension/purpose to access the mission, the serving MM 252 may jointly consider the device locations in serving XC selection.

The serving MM 252 may send, at 312, a notification message to the initial selected serving XC 186. The notification message may contain the MAR info.

After receiving the notification message sent by serving MM 252, the initial selected serving XC 186 may check whether the related requirements indicated in the MAR info (e.g., minimal data rate/maximal delay thresholds for device to PF/DPF data transmission) can be guaranteed by the initial selected serving XC 186. If the related requirements can be guaranteed, the initial selected serving XC 186 may send, at 314, a selection confirmation message, which may contain a selection confirmation indicator and the preferred communication parameters for the control link between device and serving XC 186 to the serving MM 252.

If the related requirements cannot be guaranteed by the initial selected serving XC, the initial selected serving XC 186 may send a message containing a selection fail indicator to the serving MM 252. In some embodiments, the serving MM 252 may trigger a XC selection and configuration procedure (e.g., see FIG. 8A) to re-select an appropriate XC, which may guarantee the device requirements, and may then repeat the actions 308, 310 and 312.

Build-up RAN to serving XC (R2X) interface. After receiving the response message sent by the serving MM at action 318 of FIG. 13, the CM 248 can build up the R2X interface for control signal exchanges between device and the serving XC 186.

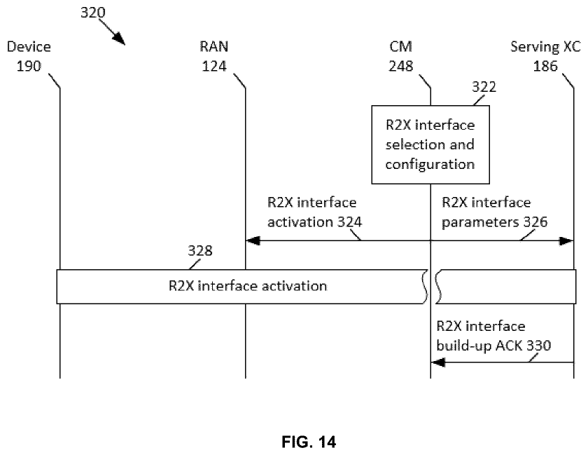

FIG. 14 shows an embodiment of a workflow (flow diagram) 320 of a procedure for a R2X interface buildup, which may include the following. The CM 248 may check, at 322, the serving XC info obtained, at 308 (FIG. 13), from the response message sent by the serving MM at action 304 (FIG. 12):
If the interface for D2X communication is sharable, the CM may further check existing R2X interfaces (and their communication parameters) between the RAN where device connected and the serving XC. If any existing R2X interface meets the communication requirements indicated in both serving XC info and MAR, the CM can directly select the R2X interface for D2X communication.
If the interface for D2X communication is not sharable, or no existing R2X interface meets the communication requirements indicated in both serving XC info and MAR, the CM customizes detailed parameters for the R2X interface which include control signal transmission protocol, minimal data rate/maximal delay thresholds for control signal transmission, etc. Then, the CM allocates communication resources in RAN and CN to build up the R2X interface.

The CM 248 may send, at 324 and 326, messages to both the RAN 124 and the serving XC 186 which contain the address and determined communication parameters for the R2X interface. Subsequently, at 328, the R2XX interface is activated.

R2X interface activation: The RAN may configure a data link between the device 190 to the RAN side of the R2X interface, and the serving XC 186 may configure the serving XC side R2X interface. In some embodiments, after completing configurations, the serving XC 186 may send a R2X activation message to the RAN 124 which contains an indicator to activate the R2X interface. After receiving the R2X activation message, the RAN may send, at 330, a R2X activation ACK message to the serving XC 186 as a response.

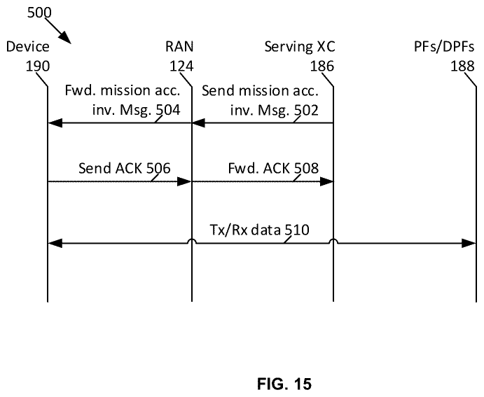

FIG. 15 shows an embodiment of a workflow (flow diagram) 500 of a method for accessing a device 190 from a XC (serving XC) 186 to invite a device 190 to access a mission, through a RAN 124. Given the R2X interface built by the CM 248, the serving XC 186 may send, at action 502, a mission access invitation message to the RAN 124 and the RAN 124 can forward, at action 504, the same message to the device 190. The contents of mission access invitation message may include, for example:
Data plane PF/DPF address/location which connects to the device.
Communication parameters for device to PF/DPF data communication (customized by serving XC according to device requested in MAR), including protocol selections, minimal data rate/maximal delay thresholds, security/privacy setting, etc.

If the device 190 accepts the access invitation, the device 190 may send, at action 506, an ACK message, i.e., a mission invitation ACK, to the RAN 124 and the RAN 124 may forward, at action 508, through the R2X interface, the ACK message to the serving XC 186. Subsequently, at action 510, data may be transmitted between the device 190 and the connected PF/DPF 188 That is, the XC enables communication between the device 190 and the PFs/DPFs 188. When the device 190 denies the mission access invitation, the device 190 sends a deny ACK message (forwarded by RAN 124) via the R2X interface to the serving XC 186.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

In various embodiments, the management and control modules include a mission management module configured to interoperate with one or more of the service modules to perform a specified mission, said mission comprising a specified set of tasks or operations. The mission management module may interoperate with two or more of the service modules to perform the specified mission, and the mission management module may cause one or more interconnections to be established between said two or more of the service modules in support of the specified mission. One or more terminals, application servers, or both, may be operatively coupled to one or more of the service modules and operate to support the specified mission.

We claim:

1. A system, comprising:
a control/management (C/M) plane, including:
a mission manager (MM) configured to manage a mission, the mission comprising tasks associated with heterogenous services provided by respective XaaS modules; and
a mission data plane, including:
processing functions (PFs), the tasks comprising the PFs, each XaaS module comprising at least one PF, each PF configured to interface with at least one of: another PF, a device and an application server; and
data plane functions (DPFs), the tasks comprising the DPFs, each DPF configured to interface a first PF of a first XaaS module to a second PF of a second XaaS module, the MM configured to manage the mission by scheduling and coordinating the tasks associated with the heterogenous services.

2. The system of claim 1, wherein the MM is configured to do at least one of:
dynamically schedule and coordinate the tasks in accordance with dynamic resource conditions or dynamic network conditions; and
schedule and coordinate the tasks in accordance with a pre-determined workflow.

3. The system of claim 1, wherein each XaaS module comprises a respective XaaS service controller (XC), each XC being coupled to the MM, each XC configured to schedule and coordinate an execution of PFs of the respective XaaS module and an execution of DPFs associated with the PFs.

4. The system of claim 1, wherein the C/M plane defines at least one of:
a network registry (NRF) function configured to store and maintain pre-determined data associated with at least one of: the PFs, the DPFs, the tasks and the mission;
a network exposure function (NEF) configured to manage an interconnection between the XaaS modules and application functions (AFs), the AFs configured to create a mission, trigger a mission or both create a mission and trigger the mission; and
a connectivity manager (CM) configured to manage an access of a device to the mission.

5. The system of claim 1, wherein:
the first XaaS module comprises a first DPF coupled to the first PF, the first DPF and the first PF forming a first XaaS data plane function (XDPF),
the second XaaS module comprises a second DPF coupled to the second PF, the second DPF and the second PF forming a second XDPF,
the first XDPF is coupled to the second XDPF,
the PF of the first XaaS service is coupled to the PF of the second XaaS service via the DPF of the first XaaS service and the DPF of the second XaaS service.

6. A method comprising:
by a network exposure function (NEF),
obtaining, from a device or an application function (AF), a mission execution request (MER) for a mission comprising tasks;
establishing a mission execution procedure to select a mission manager (MM) to manage the mission;
receiving, from the MM, a mission ready acknowledgment (ACK) message indicating the mission is ready for execution; and
forwarding the mission ready ACK message to the device or the AF to cause an execution of the mission, the device, the AF, the NEF, and the MM being comprised in network elements in a network, the network elements further comprising at least one of: a network registry function (NRF), XaaS service controllers (XCs), processing functions (PFs), data plane functions (DPFs), a device, and an application server (AS);
using the network elements other than the NEF and the NRF, to execute the tasks of the mission.

7. The method of claim 6, wherein the MM is configured to do at least one of:
conduct a XC selection and configuration procedure for a particular task to be triggered, and to conduct a trigger task execution procedure; and
conduct a mission establishment procedure to establish a partial mission data plane for the task to be triggered, then to conduct a XC selection and configuration procedure for the task to be triggered, and the then conduct a trigger task execution procedure.

8. The method of claim 6, wherein the MM is configured to monitor the current running tasks and to manage the XCs associated to the running tasks by sending task management messages to the XCs associated to the running tasks.

9. The method of claim 8, wherein the content of the task management messages includes at least one of a task suspension signal, a task waiting time to start, and a resource utilization constraint for parallel running tasks.

10. The method of claim 6, wherein for each task, the task execution is gradually conducted by the data sending, receiving and processing/computing behaviors running on the PFs and DPFs comprised in the task.

11. The method of claim 6, wherein the XC is configured to monitor the PFs and the DPFs and to provide XC management messages to the PFs and to the DPFs.

12. The method of claim 11, wherein the XC management messages comprise at least one of a PF/DPF running suspension signal, a PF/DPF waiting time start, resource utilization constraints for parallel running of the PF and the DPFs.

13. The method of claim 6, wherein the XC is configured to do at least one of:
send a mission data plane modification request message to the MM to re-select the associated PFs/DPFs due to load balancing or device access impacts;
send a notification message to the MM, the notification message comprising at least one of: a task start indicator or time, a task execution complete message, a device arrival/dropout indicator, and a task execution result; and
receive work complete messages sent by the PFs and the DPFs, the work complete messages indicating the completion of the PFs and the DPFs running.

14. The method of claim 6, wherein establishing the mission execution procedure comprises:
by the NEF,
sending, to a network registry function (NRF), a query message for mission data associated with the MER;
receiving the mission data; and
selecting the MM to manage the mission in accordance with the mission data.

15. The method of claim 14, the method further comprising:
by the MM,
receiving the MER and the mission data from the NEF;
establishing a mission data plane (MDP) in accordance with the MER and the mission data, wherein the MDP comprises processing functions (PFs) and data plane functions (DPFs);
sending, to the NRF, a query for information on available XaaS service controllers (XCs);
receiving the information on the available XCs; and
selecting, in accordance with the information on the available XCs, one of the available XCs to obtain a selected XC to manage a task comprising the PFs and the DPFs.

16. A method comprising:
by a device, sending, to a connectivity manager (CM) via a radio access network (RAN) node, a mission access request (MAR) to access the mission;
by the CM, conducting a serving mission manager (MM) procedure to select a serving MM;
by the serving MM, conducting a serving XaaS service controller (XC) procedure to select a serving XC to manage a task of a mission to be accessed by the device;
by the CM, establishing the RAN node to a serving XC interface (R2X interface) configured to control signals between the serving XC and the device; and
by the serving XC, sending an invite message to the device to join a data plane of the task via the R2X interface.

17. The method of claim 16, wherein the serving MM procedure comprises:
by the CM,
sending, to a network registry function (NRF), the MAR;
receiving, from the NRF, a response message comprising an identification and a location/address of the MM that manages the mission;
selecting as the serving MM, the MM that manages the mission; and
sending, to the device, a message identifying the serving MM.

18. The method of claim 16, wherein conducting the serving XC procedure comprises:
by the CM, sending, to the serving MM, a message to initiate a selection of the serving XC;
by the MM,
when a participant point is specified in the MAR, conducting an initial serving XC selection by selectin, an XC corresponding to the participant point; and
when a participant point is not specified in the MAR, translating an intention of the device to access the mission indicated in the MAR and to access a task of the mission, and selecting as the serving XC the XC that manages the task.

19. The method of claim 16, further comprising:
by the CM,
when a determination is made, in accordance with serving MM data, that an interface for D2X communication is sharable,
checking if there is an R2X interface with appropriate parameters between the RAN node where the device is connected and the serving XC,
when there is the R2X interface with the appropriate parameters, selecting the R2X interface for D2X communication;
when a determination is made, in accordance with the serving MM data, that the interface for D2X communication is not sharable,
setting parameters for the R2X interface, the parameters including a control signal protocol, a minimum data rate/maximum delay threshold for control signal transmission.

20. The method of claim 19, further comprising,
by the CM:
sending to the RAN and to the serving XC, messages containing an address for the R2X interface and communication parameters for the R2X interface;
activating the R2X interface; and
by the serving XC, sending an interface build-up acknowledgment message to the CM.
